(19) United States
(12) Patent Application Publication
(10) Pub. No.: US 2007/0177820 A1
(43) Pub. Date: Aug. 2, 2007

(54) System and method for providing an optical section image by direct phase angle determination and use of more than three images

(76) Inventors: Joseph J. O Ruanaidh, Hamilton, NJ (US); Yang Zhang, Bridgewater, NJ (US); Pierre Emeric, Princeton, NJ (US); Marcin R. Swiatek, Branchburg, NJ (US); Vadim Rozenfeld, Piscataway, NJ (US)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 11/341,935

(22) Filed: Jan. 27, 2006

(51) Int. Cl. G06K 9/32

(52) U.S. Cl. 382/294

(57) ABSTRACT

In a system and method for generating an image, a processor may calculate a grid pattern frequency of a plurality of images, particularly where the calculation is based on pixels transformed by a sinusoidal signal variation smoothing procedure, calculate for each of the plurality of images a phase angle of its grid pattern based on the calculated frequency, and calculate for each pixel of an output image a value in accordance with the calculated phase angles and based on values of corresponding pixels of the plurality of images, where the grid patterns are omitted from the output image, and, in particular, where the plurality of images includes more than three images.

### BACKGROUND

Obtaining a two dimensional image of a three dimensional object is often desired, for example, for the study of organisms. Imaging of the object is often conducted via a microscope. Clarity of the image is enhanced by imaging a particular two dimensional plane, a slice, of the three dimensional object.

Conventional systems generate an image of the two dimensional plane in the three dimensional object in several different ways, including deconvolution, confocal laser scanning, and optical sectioning. For optical sectioning, conventional systems project a grid pattern onto a particular plane in the three dimensional image, and construct an image out of only those pixels in which the grid pattern falls. The plane is one selected with respect to an objective. The plane of the object to be imaged depends on the object's placement with respect to the selected plane. The grid pattern refers to a pattern of changing light intensities which can be graphed as a sine wave measured in terms of pixels, so that the peak and lowest intensities occur cyclically every given number of pixels. FIG. 1 is a diagram that illustrates components of a conventional system for performing optical sectioning, for example, a microscope. A lamp 100 emits light that is radiated onto a grid 102 of horizontal lines and that is subsequently reflected by a beam splitter 104 as the grid pattern onto the object to be imaged. Light reflected by the object, including the grid pattern, is then captured as an image by a camera 106. The image is processed by a processor 108 to generate an output image. In particular, the processor 108 provides an output image constructed of only those pixels in which the grid pattern falls.

While projecting the grid pattern onto the object allows for removal of those pixels that are not of the desired plane of the object, it also adds to the obtained image an unwanted grid pattern. Accordingly, the grid 102 is moved to multiple positions, an image is obtained at each of the positions, and the images are combined to form a single image without grid lines. A piezo-electrically driven actuator 110 is provided to move the grid 102. The piezo-electrically driven actuator 110 responds to input voltages. The extent to which the piezo-electrically driven actuator 110 moves the grid 102 depends on the particular voltages applied to the piezo-electrically driven actuator 110. The particular parts of the object on which particular intensities of the grid pattern are projected depend on the position of the grid 102. The piezo-electrically driven actuator 110 is moved to move the grid between three positions. The positions are set so that the resultant intensities of corresponding grid patterns can be graphed as corresponding sine waves, where a particular point in the sine wave is phase shifted between the three grid patterns by equal phase angles, i.e., phase angles of 0 degrees, 120 degrees, and 240 degrees, each separated by 120 degrees. For each of the three positions of the grid 102, the camera 106 captures a corresponding image. FIG. 2 shows the 3 images superimposed onto each other and their corresponding grid line intensity graphs.

For each pixel, the processor 108 combines the values obtained from each of the three images using the formula Iₚ=α·\sqrt{(I₁−I₂)₂+(I₂−I₃)²+(I₃−I₁)²}, where Iₚ represents the combined pixel value, I₁, I₂, and I₃ each represents a pixel value for a respective one of the three images, and α equals

$$\frac{\sqrt{2}}{3} .$$

Since the grid pattern is phased by equal amounts of 120°, i.e., the phase angles are 0°, 120°, and 240°, the sine waves of the grid pattern at a particular pixel in the three images cancel each other out, i.e., their values average to zero. Further, a widefield image, i.e., the portion of the images at which the grid patterns are not in focus, are canceled out by I₂−I₁, I₂−I₃, and I₃−I₁. Accordingly, the value of I_{P} determined by the combination of the three images does not include the value of the corresponding point in the grid line. The output image therefore does not include the grid lines.

In order to ensure that voltages applied to the piezo-electrically driven actuator 110 are such that cause the piezo-electrically driven actuator 110 to move the grid 102 by the correct amount, where the grid pattern is phase shifted by 120 degrees, some or all conventional systems require calibration. For calibration, an object having a substantially uniform surface, such as a smooth mirror, is inserted as the object to be imaged, and three images are captured as discussed above. If the phases are incorrect, an artefact, which is a harmonic of the grid pattern frequency, appears in the combined image. Accordingly, the voltages applied to the piezo-electrically driven actuator 110, and therefore the phases, are repeatedly changed. For each change, three images are recorded and the signal power of the artefact in the combined image is measured using a Fast Fourier Transform (FFT). The changes are repeated until the signal power is determined to be below a certain threshold, indicating substantial removal of the artefact, which corresponds to approximately correct phase shifts. Once the approximately correct phase shifts are obtained, the calibration is complete.

This procedure requires combining the pixel values of each set of three images for analysis of the artefact. The procedure typically takes 45 seconds, but can take as long as 5 minutes. Further, the phase angles are not directly determined. Instead, that which approximately corresponds to an instance where the images are at the desired phase angles, i.e., a reduction below a threshold of an artefact signal, is obtained. This procedure does not allow for accurately obtaining the desired phase angles. Further, the instance where the artefact signal is below the threshold cannot be accurately determined using FFT, in particular considering the low accuracy of FFT, which can be attributed at least in part to the measurement of the signal power in discrete values. Therefore, grid lines and/or an artefact are not completely removed from the image.

Additionally, the pixel values returned by the camera 106 are often imprecise with respect to values of image intensity. Accordingly, the measurement of the intensity of the artefact is often incorrect. The piezo-electrically driven actuator 110 is therefore incorrectly calibrated.

Additionally, while the combination of the three images allows for the removal of grid lines, the procedure does not yield an optimal image.

Accordingly, there is a need in the art for a system and method that efficiently calibrates movement of the grid 102, and provides an optimal image without grid lines or an artefact.

### BRIEF DESCRIPTION OF THE DRAWINGS

FIG. 1 is a block diagram that illustrates components of a conventional imaging system for performing optical sectioning.

FIG. 2 illustrates a superimposition of three images recorded in a conventional system and their respective grid pattern intensities.

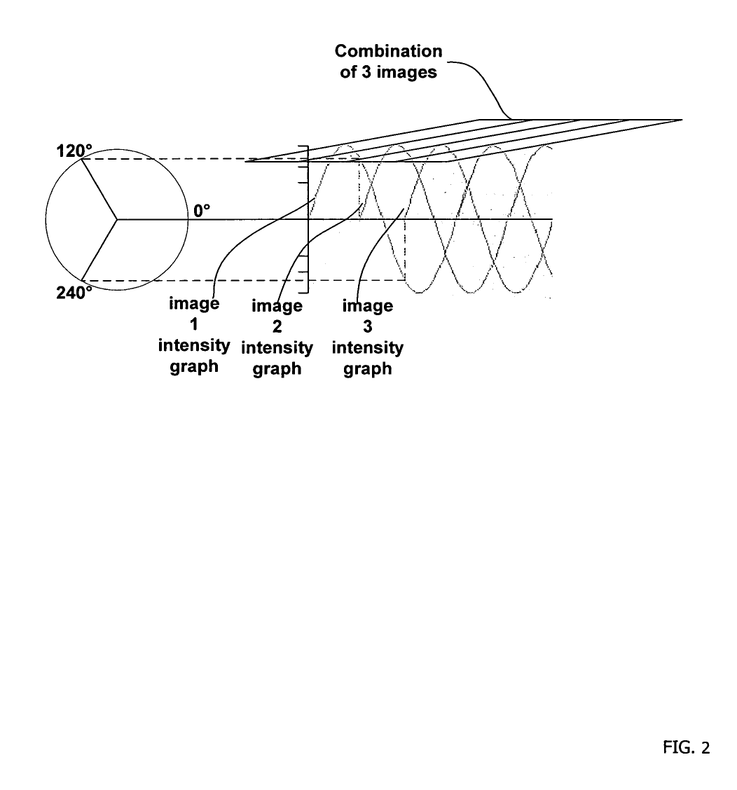

FIG. 3 is a block diagram that illustrates example components of an imaging system according to an example embodiment of the present invention.

FIG. 4 is a flowchart that illustrates a procedure for generating an optical section image according to an example embodiment of the present invention.

FIG. 5 illustrates the relationship of in-phase and quadrature components of a pixel value to an output image pixel value used for determining the output image pixel value according to an example embodiment of the present invention.

FIG. 6 is a flowchart that illustrates a second procedure for generating an optical section image according to an optical section image according to an example embodiment of the present invention.

FIG. 7 illustrates the relationship of the components r, a, b, and phase angle, where a and b are, respectively, the cosine and sine components of the magnitude.

FIG. 8 illustrates phase angles of more than three images used for generating an output image according to an example embodiment of the present invention.

FIG. 9 shows a difference between a sinusoidal variation of image intensity of an untransformed image and an image that is transformed according to an embodiment of the present invention.

### DETAILED DESCRIPTION

Embodiments of the present invention relate to an apparatus, computer system, and method for generating an image via optical sectioning by determining phase angles of a grid pattern projected successively onto an object to be imaged. Embodiments of the present invention relate to an apparatus, computer system, and method for generating an image based on phase angles of a grid pattern that are set or determined with reference to pixel values that are logarithmic values or approximate logarithmic pixel values of actually recorded pixel values. Embodiments of the present invention relate to an apparatus, computer system, and method for generating an image based on values of a plurality of images that includes more than three images combined, in particular where images of each pair of successive ones of the plurality of images is obtained at a different phase angle, i.e., no image is at a same phase angle as that of its immediately preceding image. Successive images, as used herein, refers to succession with regard to grid pattern phase angles, rather than succession in time of recordation.

The computer system may include a computer program written in any conventional computer language. Example computer languages that may be used to implement the computer system and method of the present invention may be C and/or MATLAB.

### Direct Calculation of Phase Angle

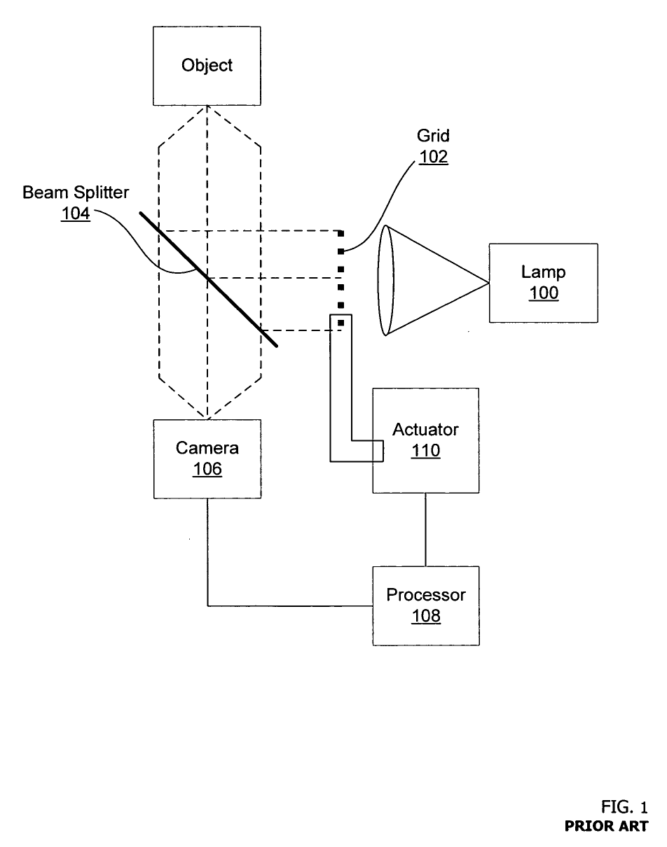

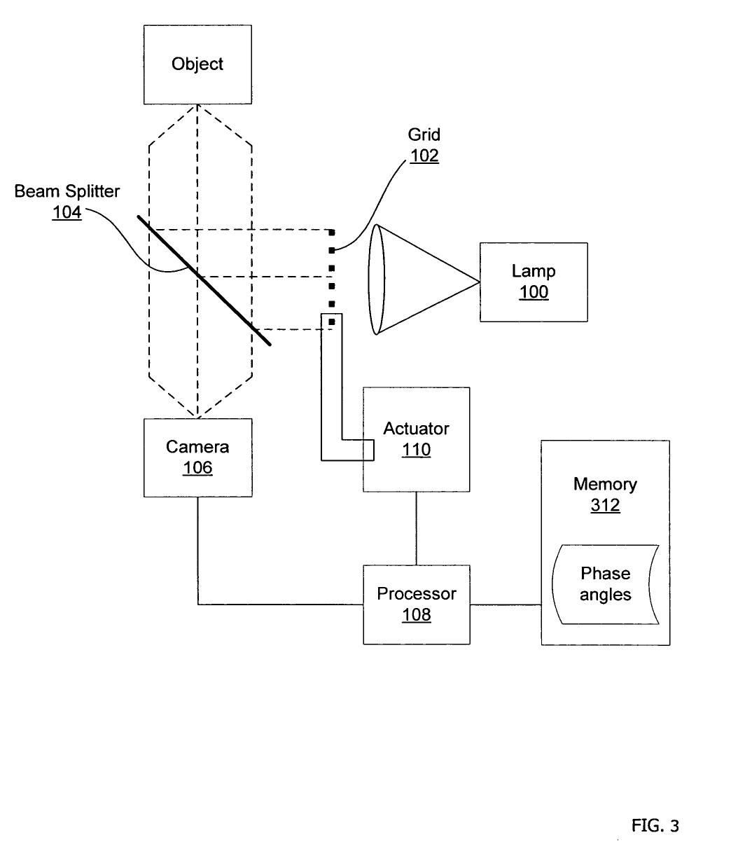

FIG. 3 illustrates components of an imaging system according to an embodiment of the present invention. Elements of FIG. 3 which are described above with respect to FIG. 1 are provided with the same reference numerals. Referring to FIG. 3, in an embodiment of the present invention, for obtaining an image of an object, the grid 102 may be moved by the piezo-electrically driven actuator 110 into three different positions. It will be appreciated that an actuator other than a piezo-electrically driven actuator may be used. Each position may be at a different phase angle. For each of the three positions, the camera 106, e.g., a CCD (charge-coupled device) camera or other conventional camera, may record a corresponding image including grid lines. The processor 108 may generate an output image based on the three recorded images. Three grid positions and corresponding images may be used in order to generate an output image based on images corresponding to grid phase angles that are offset by 120°. Alternatively, three grid positions and corresponding images, even if not offset by 120°, may be used in order to provide for each pixel three equations, one equation per image. Each equation may include three unknown variables that correspond to components of the pixel value. Each equation may be Iₙ=I_{w}+I_{c} cos φₙ+Iₛ sin φₙ, where Iₙ represents a pixel value of a particular image n of the three images, I_{w} represents the widefield component of the pixel value, φₙ represents the phase angle of the particular image n, I_{c} represents the in-phase component, and Iₛ represents the quadrature component. If the respective phase angles of the three images are determined, the values of the unknowns I_{w}, I_{c}, and Iₛ may be calculated since three equations are provided for only three unknowns.

For each of the recorded images based on the combination of which the processor 108 may generate an output image, the system may determine the image's phase angle. In this regard, the processor 108 may assign to one of the images, e.g., the first of the images, a phase angle of 0°, regardless of the corresponding grid position, since the phase angles may correspond to the phase shift between the images, without consideration of the movement of the grid lines with respect to an external object, i.e., the image phases are measured relative to one another. The processor 108 may then calculate the respective phase angles of the remaining images, representing a phase shift from the phase of the image assigned a phase angle of 0°. For determining the phase angles, the images may be taken of light reflected from a substantially uniform surface. For example, if an object that does not have a substantially uniform surface is to be imaged, insertion into the camera's line of sight of a different object having a substantially uniform surface may be required for determining the phase angles.

In an embodiment of the present invention, the processor 108 may calibrate the actuator 110 to move the grid 102 so that the phase angles are set to predetermined phase angles, e.g., phase angles of 0°, 120°, and 240°. To calibrate the actuator 110, the processor 108 may cause the camera 106 to repeatedly record a set of images. For each of the images of the set, the processor 108 may separately determine the respective image phase angles and compare them to the predetermined phase angles. Based on a deviation of the determined actual phase angles from the predetermined phase angles, the processor 108 may output new voltage values in accordance with which voltages may be applied to the actuator 110 for moving the grid 102. This cycle, i.e., applying voltages to the actuator 110, capturing a set of images, separately determining the phase angles of the images of the set, comparing the determined phase angles to the predetermined phase angles, and outputting new voltage values may be repeatedly performed until the determined actual phase angles match the predetermined phase angles within a predetermined tolerance range. If there is a match, the processor 108 may conclude the calibration without changing the voltage values. The calibration may be performed quickly since for each cycle the phase angles of the images recorded by the camera 106 are directly determined.

Subsequent to calibration, the processor 108 may generate an output image of an object, e.g., in response to a user instruction, by causing the camera 106 to record three images and setting the value of each pixel of the output image according to the formula Iₚ=α\sqrt{(I₁−I₂)²+(I₂−I₃)²+(I₃−I₁)²}.

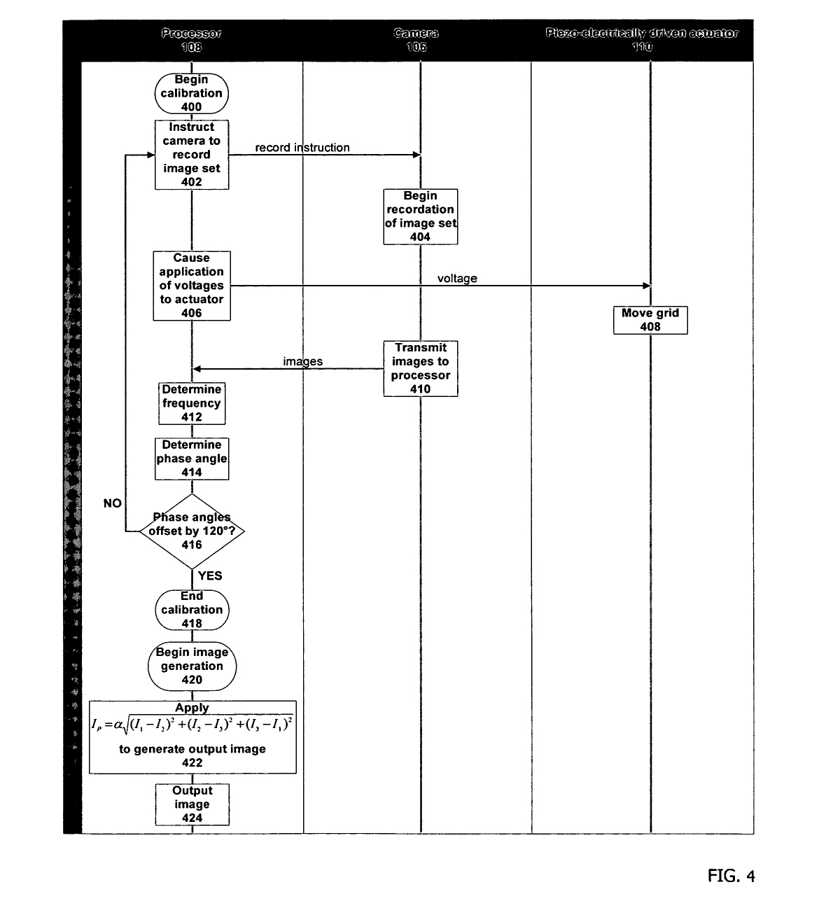

FIG. 4 is a flowchart that illustrates a procedure for obtaining an image according to this embodiment of the present invention. At 400, a calibration procedure may begin. At 402, the processor 108 may instruct the camera 106 to record of an image set, e.g., of three images. At 404, the camera may begin recordation of the image set. Between recordation of images of the set, the processor 108 may, at 406, cause the application of voltages to the peizo-electrically driven actuator 110. In response to the voltages, the actuator 110 may, at 408, move the grid 102. After recordation of the images, the camera 106 may, at 410, transmit the recorded images to the processor 108. It will be appreciated that the camera 106 may transmit each image after its recordation or may otherwise transmit them in a single batch transfer. At 414, the processor 108 may separately determine the image phase angle of each of the images. If the processor determines at 416 that the phase angles are not offset by 120°, the processor 108 may continue the calibration procedure. Otherwise, the processor 108 may end the calibration procedure at 418.

Subsequent to calibration, the processor 108 may begin an image generation procedure at 420 for an output image, e.g., in response to a user instruction. For the image generation procedure, 402-410 may be initially performed. Re-performance of 402-410 may be omitted if the object to be imaged provides sufficient data to determine image phase angles. In this regard, if an object to be imaged is itself of a uniform surface, such as a mirror, then the calibration may be performed using the object to be imaged. Accordingly, the processor 108 may use image data used in the calibration procedure for the image generation procedure. Further, even if the object to be imaged is of a non-uniform surface, it may occur that the data obtained from an image of the object is sufficient for the calibration procedure. By calculating the frequency (discussed in detail below) and phase angle for each image, the calculation results may be compared. If the results substantially match, it may be assumed that the object has provided sufficient data, i.e., imaging of a calibration slide having particular properties may be omitted. Since an object to be imaged often provides insufficient data for determining phase angle, a separate recordation of a designated object may be performed for phase angle determination. Then, at 422, the processor 108 may apply the formula Iₚ=α\sqrt{(I₁−I₂)²+(I₂−I₃)²+(I₃−I₁)²} to each pixel to generate an output image, which the processor 108 may output at 424. The image may be output via any conventional output device, such as a computer screen, projector, and/or printer.

In an alternative embodiment of the present invention, calibration may be omitted. According to this embodiment, the processor 108 may cause the camera to record a single set of images of an object having a substantially uniform surface to determine the phase angles of the images caused by movement of the grid 102. The processor 108 may save the determined phase angles in a memory 312. Alternatively, if the object to be imaged has a uniform surface or includes substantial detail so that substantial data may be obtained from an image of the object, the processor 108 may determine the image phase angles from images of the object to be imaged, without previous imaging of another object that is inserted into the camera's line of sight solely for determining image phase angles.

Subsequent to the saving of the determined phase angles in the memory 312, the processor 108 may generate an output image of an object, e.g., in response to a user instruction, by causing the camera 106 to record three images and setting the value of each pixel of the output image to a value obtained by plugging in the saved phase angles into an equation matrix and solving for the I_{c} and Iₛ components of the pixel value. As discussed above, for each of the three images, a particular pixel value is Iₙ=I_{w}+I_{c} cos φₙ+Iₛ sin φₙ. Accordingly, a particular pixel may be defined as:

$$\begin{matrix}{I}_{1} = {I}_{w} + {I}_{c} cos {ϕ}_{1} + {I}_{s} sin {ϕ}_{1} \\ {I}_{2} = {I}_{w} + {I}_{c} cos {ϕ}_{2} + {I}_{s} sin {ϕ}_{2} \\ {I}_{3} = {I}_{w} + {I}_{c} cos {ϕ}_{3} + {I}_{s} sin {ϕ}_{3}\end{matrix} or [ \begin{matrix}{I}_{1} \\ {I}_{2} \\ {I}_{3}\end{matrix} ] = [ \begin{matrix}1 & cos {ϕ}_{1} & sin {ϕ}_{1} \\ 1 & cos {ϕ}_{2} & sin {ϕ}_{2} \\ 1 & cos {ϕ}_{3} & sin {ϕ}_{3}\end{matrix} ] [ \begin{matrix}{I}_{w} \\ {I}_{c} \\ {I}_{s}\end{matrix} ] .$$

The equation matrix may be re-expressed to solve for the variables I_{w}, I_{c}, and Iₛ, as follows:

$$[ \begin{matrix}{I}_{w} \\ {I}_{c} \\ {I}_{s}\end{matrix} ] = {[ \begin{matrix}1 & cos {ϕ}_{1} & sin {ϕ}_{1} \\ 1 & cos {ϕ}_{2} & sin {ϕ}_{2} \\ 1 & cos {ϕ}_{3} & sin {ϕ}_{3}\end{matrix} ]}^{- 1} [ \begin{matrix}{I}_{1} \\ {I}_{2} \\ {I}_{3}\end{matrix} ] .$$

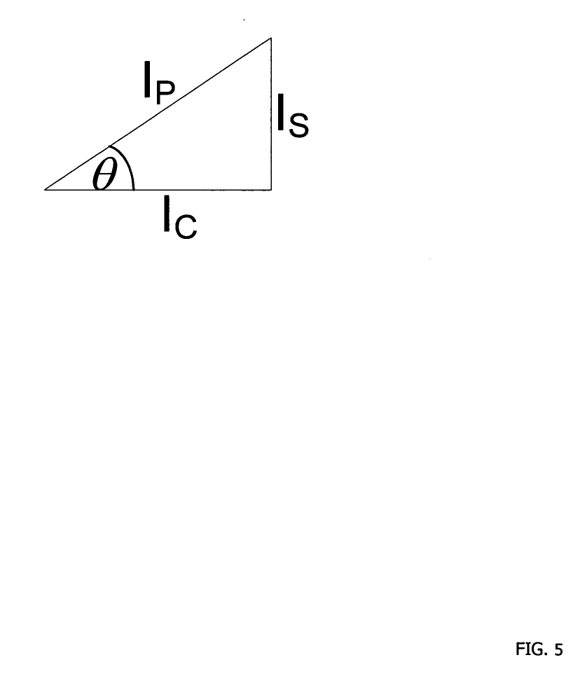

Once I_{c} and Iₛ are calculated, the processor 108 may determine the pixel value Iₚ of the output image since I_{c} and Iₛ are the in-phase and quadrature in focus components of the pixel value Iₚ, as shown in FIG. 5. (I_{w} is the widefield image). The processor 108 may determine the pixel value Iₚ according to the formula Iₚ=\sqrt{I_{c}²+Iₛ²} (the Pythagorean theorem). While the values of the pixels I₁, I₂, and I₃ may be in part based on the grid lines projected onto the object, the value of Iₚ (determined based on the components I_{c} and Iₛ) is based entirely on the object and not on the grid lines projected onto the object. Further, because of the precise or substantially precise determination of the phase angles, the image generated by a combination of the pixel values Iₚ determined according to the preceding equation does not include an artefact.

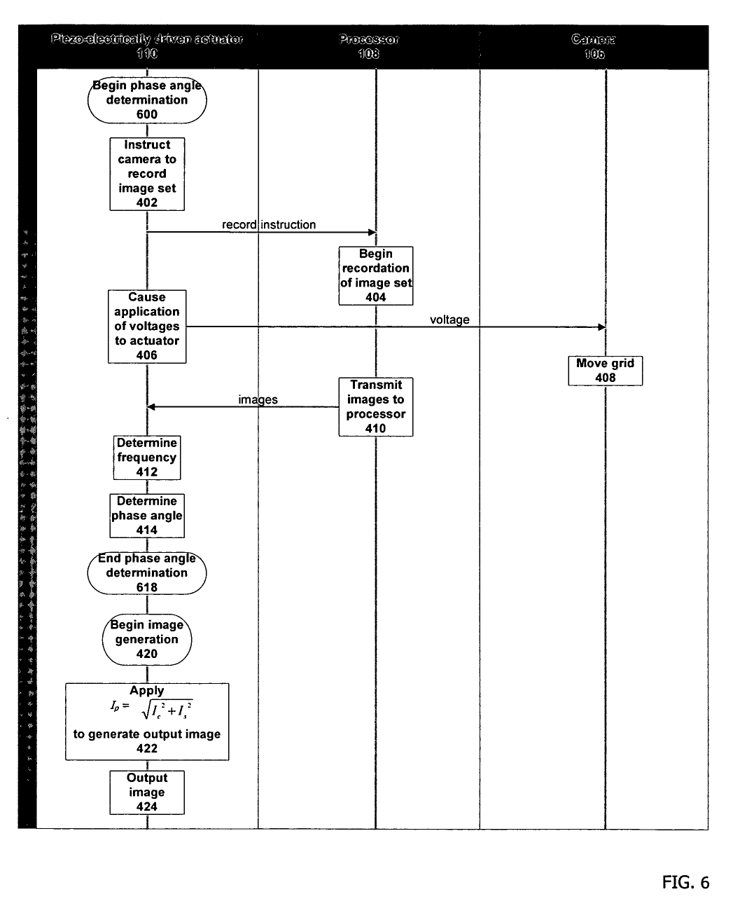

FIG. 6 is a flowchart that illustrates a procedure for obtaining an image according to this embodiment of the present invention. Elements of FIG. 6 which are described above with respect to FIG. 4 are provided with the same reference numerals. According to this embodiment, calibration is not performed. Instead, a phase angle determination procedure alone is performed. 400 and 418 are therefore replaced with 600 and 618, and the determination of 416 is not performed. With respect to 420, re-performance of 402-410 may be omitted if the object to be imaged provides sufficient data to determine image phase angles, as discussed above. Further, since calibration for obtaining phase angles offset by 120° is not performed according to this embodiment, 422 is replaced with 522 at which the formula Iₚ=\sqrt{I_{c}²+Iₛ²} is applied to generate an output image.

It will be appreciated that even according to the embodiment in which the calibration procedure is performed, the processor 208 may calculate output image pixels using the formula Iₚ=\sqrt{I_{c}²+Iₛ²}. It will be appreciated that even according to the second embodiment, if the processor 108 determines, at 414, that the image phase angles are 0°, 120°, and 240°, the processor 108 may calculate output image pixels using the formula Iₚ=α\sqrt{(I₁−I₂)²+(I₂−I₃)²+(I₃−I₁)²}.

Accordingly, by determining the phase angle of the three images, the calibration may be performed quickly. Further, by determining the phase angle, an output image may be generated based on a set of images at different phase angles even without calibrating the actuator 110 to cause the grid lines of the images of the set to be at predetermined phase angles.

Referring to FIGS. 4 and 6, in an embodiment of the present invention, the processor 108 may determine, at 412, a frequency of the grid lines of the images of the image set, and may calculate a phase angle of an image of the set based on a correlation of the pixel values of the image to the determined frequency, as discussed below. Referring specifically to FIG. 4, while in one embodiment of the present invention 412 may be performed during each iteration of the calibration procedure for quality control by comparison of determined frequencies, in an alternative embodiment 412 may be omitted during each iteration of the calibration procedure other than the first iteration, since once the frequency is known, it need not be recalculated. It will be appreciated that the frequency is not fixed. For example, the frequency may be dependent upon magnification of the reflected image or light reflected onto the object, which may depend on a position of a lens. To calculate a phase angle by correlation of pixel values to a determined frequency, it may be required for the frequency determination to be highly accurate. For example, use of FFT may be inadequate for the determination of the frequency. In an example embodiment of the present invention, the processor 108 may estimate the frequency with high accuracy using Bayesian Spectral Analysis, which will be recognized by those skilled in the art as an analysis that provides more fluid results than the discrete value results obtained using FFT.

For application of Bayesian Spectral Analysis, signal data of an image may be collected. Each signal may represented by an equation relating to a sinusoidal variation of image intensity. The equation may be f(xᵢ)=r cos(ωxᵢ+φ)+c, where r is the magnitude, c is the determined frequency, x is the pixel location, φ is the phase angle, and c is the mean of the image intensity. Regarding x, it will be appreciated that this may be either the pixel coordinate in the vertical direction or in the horizontal direction, depending on the orientation of the grid lines. For example, the orientation of the grid 102 may be such that the grid lines are projected horizontally onto the image, thereby causing variation of image intensity in the vertical direction. In this instance, the pixel coordinates may be those in the vertical direction. The sinusoidal variation of image intensity may also be represented by f(xᵢ)=a cos ωxᵢ+b sin ωxᵢ+c, where a and b are the cosine and sine components of the magnitude. Applying the latter formula to a plurality of data samples ‘d’, the following matrix formulation may be obtained:

$$[ \begin{matrix}{d}_{1} \\ {d}_{2} \\ {d}_{3} \\ ⋮ \\ {d}_{N}\end{matrix} ] = [ \begin{matrix}cos ω {x}_{1} & sin ω {x}_{1} & 1 \\ cos ω {x}_{2} & sin ω {x}_{2} & 1 \\ cos ω {x}_{3} & sin ω {x}_{3} & 1 \\ ⋮ & & \\ cos ω {x}_{N} & sin ω {x}_{N} & 1\end{matrix} ] [ \begin{matrix}a \\ b \\ c\end{matrix} ] + [ \begin{matrix}{e}_{1} \\ {e}_{2} \\ {e}_{3} \\ ⋮ \\ {e}_{N}\end{matrix} ] .$$

A matrix may thus be obtained, where:

$$G = [ \begin{matrix}cos ω {x}_{1} & sin ω {x}_{1} & 1 \\ cos ω {x}_{2} & sin ω {x}_{2} & 1 \\ cos ω {x}_{3} & sin ω {x}_{3} & 1 \\ ⋮ & ⋮ & \\ cos ω {x}_{N} & sin ω {x}_{N} & 1\end{matrix} ] .$$

The linear coefficients and the noise standard deviation may be integrated out. The frequency may then be obtained by applying the G matrix to the formula

$$p ( ω \text{\vert} d , I ) ∝ \frac{{[ {d}^{T} d - {d}^{T} {G ( {G}^{T} G )}^{- 1} {G}^{T} d ]}^{\frac{M - N}{2}}}{\sqrt{det ( {G}^{T} G )}} .$$

M is the number of columns included in the G matrix. Samples of a single one of the images may be sufficient for determining the frequency.

Once the frequency is determined, the phase angle of an image may be determined. For a pixel value of the image, the a and b components of a cos ωxᵢ+b sin ωxᵢ+c may be estimated by using linear regression of the pixel value to the determined frequency. Once a and b are estimated, the phase angle of the image may be calculated as arctan

$$( \frac{b}{a} )$$

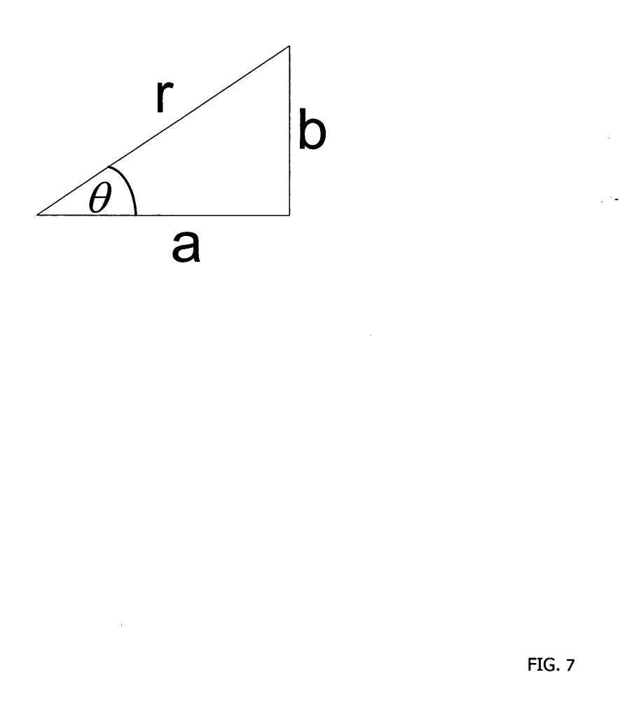

according to the relationship shown in FIG. 7. The determination of a phase angle of any single image may be performed without data regarding the other images of the set. For example, referring to FIGS. 4 and 6, 412 and 414 may be performed as soon as an image is received from the camera 106, even if the camera 106 transmits each image separately immediately subsequent to its recordation. Accordingly, while the actuator 110 moves the grid 102 for preparation of recordation of a subsequent image and/or while the camera 106 records a subsequent image, the processor 108 may perform 412 and 414 for a previously received image.

### Use of More than Three Images

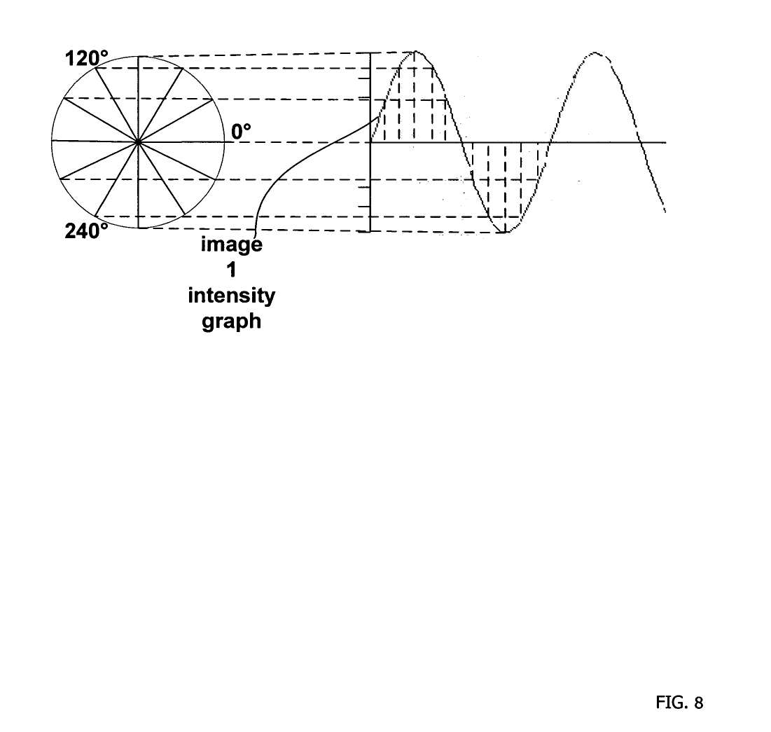

As discussed in detail above, the image generation procedure may be performed by determining a pixel value based on a combination of corresponding pixel values of a set of images, where for each image grid lines are projected at a different phase angle. While three images are conventionally included in a set of images used to generate an output image, in an embodiment of the present invention, to obtain a better quality image, the processor 108 may generate an output image based on pixel values of more than three images. For example, the offset between phase angles may be decreased as shown in FIG. 8. FIG. 8 shows a 30° phase angle offset between images. For clarity, only the intensity graph of a single image, i.e., the reference image, is shown. The dashed lines indicate the start of other image intensity graphs. According to this embodiment, the matrix formulation

$$[ \begin{matrix}{I}_{1} \\ {I}_{2} \\ {I}_{3}\end{matrix} ] [ \begin{matrix}1 & cos {ϕ}_{1} & sin {ϕ}_{1} \\ 1 & cos {ϕ}_{2} & sin {ϕ}_{2} \\ 1 & cos {ϕ}_{3} & sin {ϕ}_{3}\end{matrix} ] [ \begin{matrix}{I}_{w} \\ {I}_{c} \\ {I}_{s}\end{matrix} ]$$

may be replaced with

$$[ \begin{matrix}{I}_{1} \\ ⋮ \\ {I}_{M}\end{matrix} ] = [ \begin{matrix}1 & cos {ϕ}_{1} & sin {ϕ}_{1} \\ ⋮ & & \\ 1 & cos {ϕ}_{M} & sin {ϕ}_{M}\end{matrix} ] [ \begin{matrix}{I}_{w} \\ {I}_{c} \\ {I}_{s}\end{matrix} ] .$$

With determination of the phase angles as discussed above, a set of more than three images provides more equations than unknowns, since only I_{w}, I_{c}, and Iₛ are unknown. It may be that the equations do not completely agree because of noise. Accordingly, a regression analysis, e.g., least squares regression, may be applied for I_{w}, I_{c}, and Iₛ, which may reduce the noise present in the signals. In particular, the following least squares regression formula may be applied:

$$[ \begin{matrix}{I}_{w} \\ {I}_{c} \\ {I}_{s}\end{matrix} ] = {( {G}^{T} G )}^{- 1} {G}^{T} [ \begin{matrix}{I}_{1} \\ {I}_{2} \\ {I}_{3} \\ ⋮ \\ {I}_{M}\end{matrix} ] , {where ( {G}^{T} G )}^{- 1} = [ \begin{matrix}\frac{1}{M} & 0 & 0 \\ 0 & \frac{2}{M} & 0 \\ 0 & 0 & \frac{2}{M}\end{matrix} ] ,$$

$$G = [ \begin{matrix}1 & cos {ϕ}_{1} & sin {ϕ}_{1} \\ ⋮ & & \\ 1 & cos {ϕ}_{M} & sin {ϕ}_{M}\end{matrix} ] ,$$

and G^{T} is the transpose of G. This formula may be applied even if only three images are used.

If the phase angles of each pair of successive ones of the more than three images are offset by an equal number of degrees, other formulae may be applied. Regardless of the number of images (M) of the set, I_{w}, I_{c}, and Iₛ may be calculated as:

$$\begin{matrix}{I}_{w} = \frac{1}{M} {\sum }_{k = 0}^{M - 1} {I}_{k + 1} & \\ {I}_{c} = \frac{2}{M} {\sum }_{k = 0}^{M - 1} {I}_{k + 1} & cos ( \frac{2 π k}{M} ) \\ {I}_{s} = \frac{2}{M} {\sum }_{k = 0}^{M - 1} {I}_{k + 1} & sin ( \frac{2 π k}{M} ) .\end{matrix}$$

This formula may be applied even where M=3. Once I_{c} and Iₛ are calculated using either of the preceding two formulae, Iₚ may be calculated using the formula Iₚ=\sqrt{I_{c}²+Iₛ²}. Further, if four images are used and phase angles of each pair of successive ones of the four images are offset by an equal number of degrees, Iₚ may be calculated using the formula Iₚ=\sqrt{(I₁−I₃)²+(I₂−I₄)²}.

In an embodiment of the present invention, the pixel values of the generated image may be recursively updated to account for newly obtained images by modifying the least squares solution according to conventional procedures for updating a least squares solution. Accordingly, after an image based on pixel data of three or more images is output, a user may instruct the processor 108 to generate a more enhanced image. In response, the processor 108 may obtain a newly recorded image (including a grid pattern) and may update the already calculated values of I_{c} and Iₛ, without re-performing the calculation using the images previously used. Accordingly, it is not required for the images previously used to be stored in case an update is desired.

### Conversion of Pixel Data for Estimating Parameters

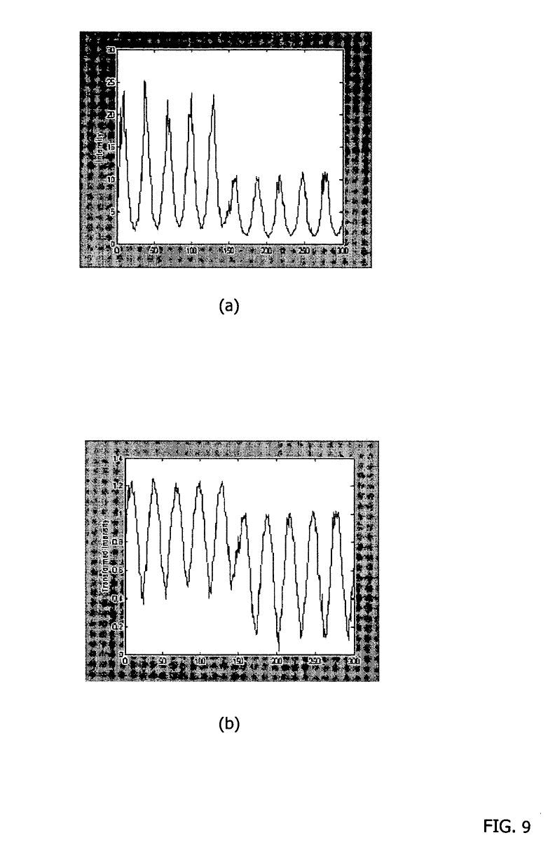

The pixel values of an image returned by the camera 106 often provide a non-uniform sinusoidal variation in image intensity. Accordingly, calibration of the actuator 110 to provide for particular phase angles, whether based on measurement with FFT of an artefact or based on direct calculation of phase angles, and/or calculation of phase angles for generating an output image based on Iₚ=\sqrt{I_{c}²+Iₛ²}, may be faulty if based on pixel values recorded by the camera 106. In an embodiment of the present invention, the system may substitute each recorded pixel value used for calibration or for determining phase angles (and/or frequency) with a value obtained by a logarithmic or approximately logarithmic conversion of the pixel value. The resultant values may provide a more uniform sinusoidal variation in image intensities. FIG. 9 shows a difference between the sinusoidal variation of image intensity of an untransformed image and a transformed image. Whereas the amplitude of the sine wave in graph (a), which represents the image intensity of an untransformed image, is substantially non-uniform, the amplitude of the sine wave in graph (b), which represents the image intensity of a transformed image, is substantially more uniform.

Subsequent to the conversion, either conventional calibration or calibration according to directly calculated phase angles, may be performed. Alternatively, the phase angles may be calculated without calibration as discussed in detail above. Subsequent to calibration and/or calculation of the phase angles, the processor 108 may generate an output image based on the untransformed, i.e., originally recorded, pixel values according to the procedures discussed in detail above.

In one embodiment of the present invention, for conversion of the recorded pixel values, a simple transformation of each pixel to its logarithmic value may be performed. According to this embodiment, an adverse effect may be realized where noise at low image intensity is amplified, distorting the image intensity values. In an alternative embodiment, an inverse hyperbolic sine function

$${sinh}^{- 1} ( \frac{x}{2} )$$

may be used for each pixel, where x is the originally recorded image intensity value. The latter function approximates the function log(x) to base ‘e’ (natural logarithms) with respect to large pixel values, but not for smaller values. According to this embodiment, amplification of noise at low image intensities may be avoided. It will be appreciated that the transformation of pixel values may be performed using any function that smoothens the amplitudes of the sinusoidal variations in intensity across an image.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An image generation method, comprising:
recording a first plurality of images;
calculating a phase angle of a grid pattern of at least one of the first plurality of images; and
calculating for each pixel of an output image a value in accordance with the calculated at least one phase angle and based on corresponding pixel values of at least one of the first plurality of images and a second plurality of images having grid pattern phase angles corresponding to grid pattern phase angles of the first plurality of images.

2. The image generation method of claim 1, further comprising:
assigning to a first one of the first plurality of images a phase angle of 0° regardless of its calculated phase angle, and assigning to each other one of the first plurality of images a phase angle offset from 0° by an amount equal to an offset between its calculated phase angle and the calculated phase angle of the first image.

3. The image generation method of claim 1, further comprising:
calculating a frequency of the grid pattern of the at least one image;
wherein the phase angle is calculated based on the calculated frequency.

4. The image generation method of claim 3, wherein the frequency is calculated via Bayesian Spectral Analysis.

5. The image generation method of claim 4, wherein the frequency is calculated based on data of a single one of the at least one image.

6. The method of claim 4, wherein:
the frequency is calculated by applying a formula
$$p ( ω \vert d , I ) ∝ \frac{{[ {d}^{T} d - {d}^{T} {G ( {G}^{T} G )}^{- 1} {G}^{T} d ]}^{\frac{M - N}{2}}}{\sqrt{det ( {G}^{T} G )}} ,$$
in which ω represents the frequency;
G is a matrix
$$[ \begin{matrix}cos ω {x}_{1} & sin ω {x}_{1} & 1 \\ cos ω {x}_{2} & sin ω {x}_{2} & 1 \\ cos ω {x}_{3} & sin ω {x}_{3} & 1 \\ ⋮ & ⋮ & \\ cos ω {x}_{N} & sin ω {x}_{N} & 1\end{matrix} ] ; and$$
x is an identification of a pixel location from which corresponding data of the matrix is obtained.

7. The image generation method of claim 6, further comprising:
estimating values of a and b of f(xᵢ)=a cos ωxᵢ+b sin ωxᵢ+c by correlation of a pixel value to the calculated frequency using linear regression;
wherein the phase angle is calculated to be equal to
$$arctan ( \frac{b}{a} ) .$$

8. The image generation method of claim 3, further comprising:
calibrating an actuator to shift a grid between recordation of each image of the first and second pluralities of images so that phase angle offsets between grid patterns of each pair of successive images of each single plurality are equal.

9. The image generation method of claim 8, wherein:
each of at least one of the first and second pluralities of images includes more than three images;
the value of each pixel of the output image is calculated using a formula Iₚ=\sqrt{I_{c}²+Iₛ²};
Iₚ is the value of the pixel;
I_{c} and Iₛ are calculated using a formula
$$\begin{matrix}{I}_{w} = \frac{1}{M} {\sum }_{k = 0}^{M - 1} {I}_{k + 1} & \\ {I}_{c} = \frac{2}{M} {\sum }_{k = 0}^{M - 1} {I}_{k + 1} & cos ( \frac{2 π k}{M} ) ; and \\ {I}_{s} = \frac{2}{M} {\sum }_{k = 0}^{M - 1} {I}_{k + 1} & sin ( \frac{2 π k}{M} ) \end{matrix}$$
M is equal to a number of images included in the each of the at least one of the first and second pluralities of images.

10. The image generation method of claim 8, wherein each of at least one of the first and second pluralities of images includes four images, the value of each pixel of the output image is calculated using a formula Iₚ=\sqrt{(I₁−I₃)²+(I₂−I₄)²}, and Iₚ is the value of the pixel.

11. The image generation method of claim 8, wherein the phase angle offsets are 120°.

12. The image generation method of claim 8, wherein, for the calibrating of the actuator, pluralities of images are repeatedly recorded until determined phase angles of each pair of successive images of a single plurality are determined to be offset by equal amounts, the method further comprising:
after each recordation of a plurality of images during the during the calibrating of the actuator, changing a voltage to be applied to the actuator upon a condition that phase angle offsets between pairs of successive images of the plurality are unequal.

13. The image generation method of claim 1, wherein the value of each pixel of the output image is calculated using a formula Iₚ=\sqrt{I_{c}²+Iₛ²}, Iₚ is the value of the pixel, and I_{c} and Iₛ are calculated using a formula
$$[ \begin{matrix}{I}_{w} \\ {I}_{c} \\ {I}_{s}\end{matrix} ] = {[ \begin{matrix}1 & cos {ϕ}_{1} & sin {ϕ}_{1} \\ 1 & cos {ϕ}_{2} & sin {ϕ}_{2} \\ 1 & cos {ϕ}_{3} & sin {ϕ}_{3}\end{matrix} ]}^{- 1} [ \begin{matrix}{I}_{1} \\ {I}_{2} \\ {I}_{3}\end{matrix} ] .$$

14. The image generation method of claim 13, wherein:
the grid pattern is substantially removed from the output image; and
phase angle offsets between grid patterns of different pairs of successive ones of the first plurality of images are unequal.

15. The image generation method of claim 14, wherein:
each of at least one of the first and second pluralities of images includes more than three images;
the value of each pixel of the output image is calculated using a formula Iₚ=\sqrt{I_{c}²+Iₛ²};
Iₚ is the value of the pixel; and
I_{c} and Iₛ are calculated using a regression analysis.

16. The image generation method of claim 15, wherein:
I_{c} and Iₛ are calculated using least squares regression by applying a formula
$$[ \begin{matrix}{I}_{w} \\ {I}_{c} \\ {I}_{s}\end{matrix} ] = {( {G}^{T} G )}^{- 1} {G}^{T} [ \begin{matrix}{I}_{1} \\ {I}_{2} \\ {I}_{3} \\ ⋮ \\ {I}_{M}\end{matrix} ] ;$$
(G^{T}G)⁻¹ is equal to
$$[ \begin{matrix}\frac{1}{M} & 0 & 0 \\ 0 & \frac{2}{M} & 0 \\ 0 & 0 & \frac{2}{M}\end{matrix} ] ; and$$
G is equal to
$$[ \begin{matrix}1 & cos {ϕ}_{1} & sin {ϕ}_{1} \\ ⋮ & & \\ 1 & cos {ϕ}_{M} & sin {ϕ}_{M}\end{matrix} ] .$$

17. The image generation method of claim 13, wherein:
the grid pattern is substantially omitted from the output image; and
phase angle offsets between at least one pair of successive ones of the first plurality of images is one of more than and less than 120°.

18. The image generation method of claim 1, further comprising:
for calculating the phase angle, transforming image pixel values of the at least one image to smoothen amplitudes of sinusoidal variations in image intensity across the at least one image;
wherein, for calculating the pixels of the output image, the corresponding pixel values are used in an untransformed state.

19. The image generation method of claim 18, wherein the pixel values are transformed to their respective logarithmic values.

20. The image generation method of claim 18, wherein:
the pixel values are transformed by applying an inverse hyperbolic sine function to
$$( \frac{x}{2} ) ;$$
and
x represents an untransformed pixel value.

21. An image generation method, comprising:
calculating for each pixel of an output image a value based on values of corresponding pixels in a plurality of images, wherein:
the plurality of images includes more than three images;
each of the more than three images includes a grid pattern; and
the grid patterns are substantially omitted from the output image.

22. The image generation method of claim 21, wherein:
the value of each pixel of the output image is calculated using a formula Iₚ=\sqrt{I_{c}²+Iₛ²};
Iₚ is the value of the pixel; and
I_{c} and Iₛ are calculated using a regression analysis.

23. The image generation method of claim 22, wherein:
input of the regression analysis is
$$[ \begin{matrix}{I}_{1} \\ ⋮ \\ {I}_{M}\end{matrix} ] = [ \begin{matrix}1 & cos {ϕ}_{1} & sin {ϕ}_{1} \\ ⋮ & & \\ 1 & cos {ϕ}_{M} & sin {ϕ}_{M}\end{matrix} ] [ \begin{matrix}{I}_{w} \\ {I}_{c} \\ {I}_{s}\end{matrix} ] ; and$$
φ is a phase angle of a grid pattern of a corresponding image, the method further comprising:
determining for each of the plurality of images a phase angle of its grid pattern.

24. The image generation method of claim 23, wherein:
I_{c} and Iₛ are calculated using least squares regression by applying a formula
$$[ \begin{matrix}{I}_{w} \\ {I}_{c} \\ {I}_{s}\end{matrix} ] = {( {G}^{T} G )}^{- 1} {G}^{T} [ \begin{matrix}{I}_{1} \\ {I}_{2} \\ {I}_{3} \\ ⋮ \\ {I}_{M}\end{matrix} ] ;$$
(G^{T}G)⁻¹ is equal to
$$[ \begin{matrix}\frac{1}{M} & 0 & 0 \\ 0 & \frac{2}{M} & 0 \\ 0 & 0 & \frac{2}{M}\end{matrix} ] ; and$$
G is equal to
$$[ \begin{matrix}1 & cos {ϕ}_{1} & sin {ϕ}_{1} \\ ⋮ & & \\ 1 & cos {ϕ}_{M} & sin {ϕ}_{M}\end{matrix} ] .$$

25. The image generation method of claim 24, wherein phase angle offsets between grid patterns of different pairs of successive ones of the plurality of images are unequal.

26. The image generation method of claim 22, wherein I_{c} and Iₛ are calculated using least squares regression, the method further comprising:
subsequent to the calculation of the pixel values of the output image, obtaining another image including a grid pattern; and
recursively updating the pixel values of the output image based on data of the another image.

27. The image generation method of claim 21, wherein:
phase angle offsets between grid patterns of successive ones of the plurality of images are equal;
the value of each pixel of the output image is calculated using a formula Iₚ=\sqrt{I_{c}²+Iₛ²};
Iₚ is the value of the pixel;
I_{c} and Iₛ are calculated using a formula
$$\begin{matrix}{I}_{w} = \frac{1}{M} {\sum }_{k = 0}^{M - 1} {I}_{k + 1} \\ {I}_{c} = \frac{2}{M} {\sum }_{k = 0}^{M - 1} {I}_{k + 1} cos ( \frac{2 π k}{M} ) ; and \\ {I}_{s} = \frac{2}{M} {\sum }_{k = 0}^{M - 1} {I}_{k + 1} sin ( \frac{2 π k}{M} )\end{matrix}$$
M is equal to a number of images included in the plurality of images.

28. The image generation method of claim 21, wherein:
the plurality of images includes four images;
each phase angle offset between grid patterns of successive ones of the plurality of images is equal to 90°; and
the value of each pixel of the output image is calculated using a formula Iₚ=\sqrt{(I₁−I₃)²+(I₂−I₄)²}.

29. An image generation method, comprising:
calculating for each of a plurality of images a phase angle of a grid pattern of the image; and
based on the calculated phase angles, calculating for each pixel of an output image a value based on values of corresponding pixels in the plurality of images, the grid patterns being omitted from the output image.

30. The image generation method of claim 29, wherein the value of each pixel of the output image is calculated using a formula Iₚ=\sqrt{I_{c}²+Iₛ²}, Iₚ is the value of the pixel, and I_{c} and Iₛ are calculated using a formula
$$[ \begin{matrix}{I}_{w} \\ {I}_{c} \\ {I}_{s}\end{matrix} ] = {[ \begin{matrix}1 & cos {ϕ}_{1} & sin {ϕ}_{1} \\ 1 & cos {ϕ}_{2} & sin {ϕ}_{2} \\ 1 & cos {ϕ}_{3} & sin {ϕ}_{3}\end{matrix} ]}^{- 1} [ \begin{matrix}{I}_{1} \\ {I}_{2} \\ {I}_{3}\end{matrix} ] .$$

31. A computer-readable medium having stored thereon instructions adapted to be executed by a processor, the instructions which, when executed, cause the processor to perform an image generation method, the image generation method comprising:
calculating a phase angle of a grid pattern of at least one of a first plurality of images; and
calculating for each pixel of an output image a value in accordance with the calculated at least one phase angle and based on corresponding pixel values of at least one of the first plurality of images and a second plurality of images having grid pattern phase angles corresponding to grid pattern phase angles of the first plurality of images.

32. An image generation method, comprising:
recording a first plurality of images;
transforming image pixel values of the first plurality of images to smoothen amplitudes of sinusoidal variations in image intensity across the images, the sinusoidal variations representing a grid pattern;
one of (a) calibrating an actuator and (b) calculating phase angles of grid patterns of the images based on the transformed pixel values; and
calculating for each pixel of an output image a value based on corresponding pixel values of one of the first plurality of images and a second plurality of images having grid pattern phase angles corresponding to grid pattern phase angles of the first plurality of images.

33. An image generation method, comprising:
recording a first plurality of images;
calculating a phase angle of a grid pattern of at least one of the first plurality of images; and
calculating for each pixel of an output image a value in accordance with the calculated at least one phase angle and based on corresponding pixel values of at least one of the first plurality of images and a second plurality of images having grid pattern phase angles corresponding to grid pattern phase angles of the first plurality of images.

34. The image generation method of claim 1, further comprising:
for calculating the phase angle, transforming image pixel values of the at least one image to smoothen amplitudes of sinusoidal variations in image intensity across the at least one image;
wherein, for calculating the pixels of the output image, the corresponding pixel values are used in an untransformed state.
